(19) United States
(12) Patent Application Publication
(10) Pub. No.: US 2014/0223136 A1
(43) Pub. Date: Aug. 7, 2014

(54) Lookup Tables Utilizing Read Only Memory and Combinational Logic

(71) Applicant: LSI CORPORATION, San Jose, CA (US)

(72) Inventors: Zhiwei Wu, Shanghai (CN); Zhi Bin Li, Shanghai (CN); Xiangdong Guo, Shanghai (CN); Rui Shen, Shanghai (CN); Razmik Karabed, San Jose, CA (US); Wu Chang, Sunnyvale, CA (US)

(73) Assignee: LSI CORPORATION, San Jose, CA (US)

(21) Appl. No.: 13/761,892

(22) Filed: Feb. 7, 2013

(51) Int. Cl. G06F 12/10

(52) U.S. Cl. CPC G06F 12/1009
USPC 711/206

(57) ABSTRACT

The disclosure is directed to a system and method for accessing one or more values of a lookup table. In some embodiments, one or more read only memory devices are configured for storing a first plurality of values of the lookup table, and one or more combinational logic circuits are configured for accessing a second plurality of values of the lookup table. At least one of hardware area and timing pressures are mitigated through various storage and access schemes.

### FIELD OF INVENTION

The disclosure relates to the field of lookup tables for data encoding and decoding.

### BACKGROUND

Lookup tables are common in hardware architecture of encoders and decoders to determine output data for downstream logic based on input addresses corresponding to values of a lookup table. The bit width of an address determines the number of elements in a lookup table. Typically, there are 2̂(bit width of address) elements in a lookup table. With the increasing complication of encoder/decoder design, larger lookup tables are required. Accordingly, hardware area and timing pressures are relevant in the current state of the art.

### SUMMARY

Various embodiments of the disclosure include a system for accessing one or more values of a lookup table. The system includes one or more read only memory devices storing a first plurality of values of the lookup table and one or more combinational logic circuits for accessing a second plurality of values of the lookup table.

In an embodiment, the lookup table includes a plurality of sub-lookup tables. A first plurality of sub-lookup tables are stored by the one or more read only memory devices and a second plurality of sub-lookup tables are stored by the one or more combinational logic circuits.

In another embodiment, a primary value of each row of a plurality of rows of the lookup table and a plurality of delta values for each row of the plurality of rows of the lookup table are stored by the one or more read only memory devices. A plurality of secondary values of each row are accessed via the one or more combinational logic circuits, wherein each one of the plurality of secondary values is determined utilizing the primary value of each row and at least one delta value of the plurality of delta values for each row.

In yet another embodiment, a primary row of the lookup table is stored by the one or more read only memory devices. A plurality of secondary rows of the lookup table are accessed via the one or more combinational logic circuits, wherein each value of each row of the plurality of secondary rows is determined utilizing a primary value of the primary row and an eigenvector value.

It is to be understood that both the foregoing general description and the following detailed description are not necessarily restrictive of the disclosure. The accompanying drawings, which are incorporated in and constitute a part of the specification, illustrate embodiments of the disclosure.

### BRIEF DESCRIPTION OF THE DRAWINGS

The embodiments of the disclosure may be better understood by those skilled in the art by reference to the accompanying figures in which:

FIG. 1 depicts a block diagram illustrating a system for writing data to storage media, in accordance with an embodiment of the disclosure;

FIG. 2A depicts a first table illustrating properties of a lookup table and a second table illustrating properties of a selected number of sub-lookup tables making up the lookup table, in accordance with an embodiment of the disclosure;

FIG. 2B depicts a block diagram illustrating a system for accessing one or more values of the lookup table, in accordance with an embodiment of the disclosure;

FIG. 3 depicts a first table illustrating properties of various lookup tables and a second table illustrating properties of the various lookup tables after subtracting a common value, in accordance with an embodiment of the disclosure;

FIG. 4A depicts a table illustrating properties of a lookup table and a matrix associated with an element of the lookup table, in accordance with an embodiment of the disclosure;

FIG. 4B depicts a block diagram illustrating a system for accessing one or more values of the lookup table, in accordance with an embodiment of the disclosure;

FIG. 4C depicts a block diagram illustrating a system for accessing one or more values of the lookup table, in accordance with an embodiment of the disclosure;

FIG. 4D depicts a block diagram illustrating a system for accessing one or more values of the lookup table, in accordance with an embodiment of the disclosure;

FIG. 5 depicts a matrix associated with a portion of a look table, in accordance with an embodiment of the disclosure;

FIG. 6A depicts a table illustrating properties of a lookup table and a matrix associated with an element of the lookup table, in accordance with an embodiment of the disclosure;

FIG. 6B depicts a block diagram illustrating a system for accessing one or more values of the lookup table, in accordance with an embodiment of the disclosure; and

FIG. 7 depicts a first block diagram illustrating a multiple-output lookup table and a second block diagram illustrating a plurality of single-output lookup tables, in accordance with an embodiment of the disclosure.

### DETAILED DESCRIPTION

Reference will now be made in detail to the embodiments disclosed, which are illustrated in the accompanying drawings.

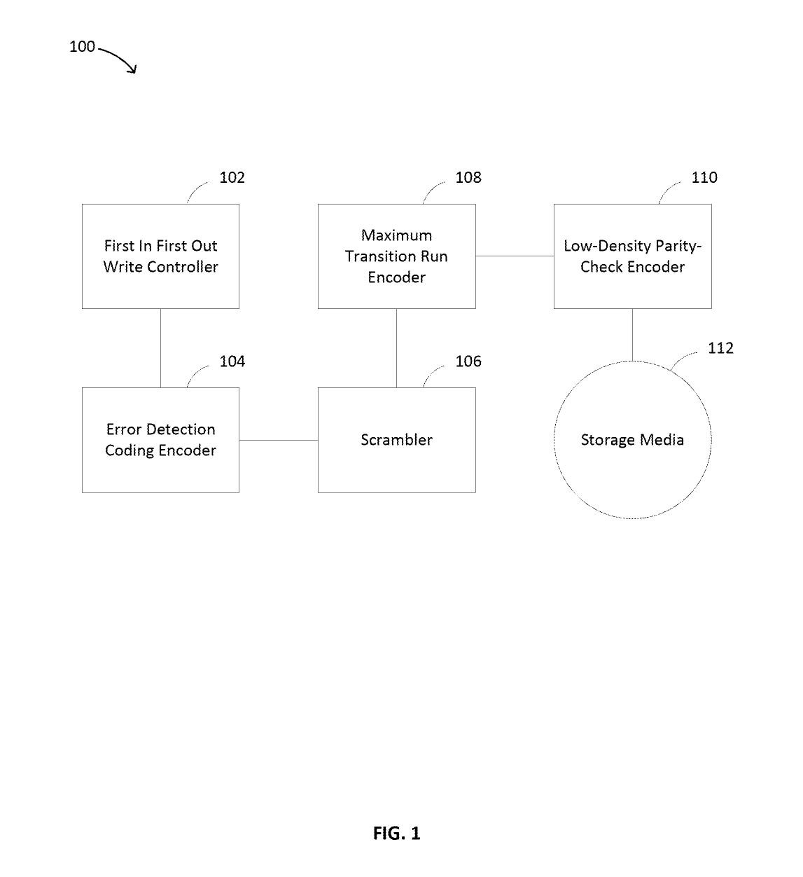

FIG. 1 illustrates an embodiment of a system 100 for writing data to at least one storage medium 112, such as a hard disk drive (HDD). In some embodiments, the system is configured for state-splitting maximum transition run (MTR) coding combined with low-density parity-check (LDPC) coding. According to the embodiment illustrated in FIG. 1, data is received through a first-in-first-out (FIFO) write controller 102. The write controller 102 is configured to send the data to an error detection coding (EDC) encoder 104. The EDC encoded data is then scrambled by a scrambler 106 before being sent to a MTR encoder 108. The MTR encoder 108 is configured to encode the scrambled data to a MTR data pattern which satisfies maximum transition run rule. The MTR encoded data is transmitted to an LDPC encoder 110. The LDPC encoder 110 is configured to write the data to the storage media 112 with LDPC parity.

In some embodiments, the MTR coding method is based on state splitting. In addition to the traditional hard MTR constraint, a soft MTR constraint is also applied to the encoded data. State-splitting MTR algorithms are known to the art. In some embodiments, the algorithm requires initial construction of a basic MTR matrix which satisfies hard MTR rules. Then the basic MTR matrix is extended to a larger transition matrix allowing the coding performance to approach Shannon Capacity. During the encoding, the input data is mapped to a unique path on the transition matrix, which is called edge and has a label on it, where the label is the encoded data. According to the algorithm, for the MTR encoder and decoder, a relatively large number of lookup tables (LUTs) are necessary for determining the relationship between edge and input data.

In some embodiments, the LUTs occupy a large area of hardware and/or attribute to system timing pressures, often depending upon the hardware selection and architecture. Read only memory (ROM) devices typically occupy less area than combinational logic circuits (e.g. logic gates, multiplexer arrays). However, access to LUT values through ROM is also typically slower than combinational logic. Several of the following embodiments are directed to LUT hardware architecture designed to reduce at least one of area and/or timing pressures, among other improvements.

According to the embodiments described herein, various steps or functions are executed by hardware, software, firmware, or any combination of the foregoing. In some embodiments, at least one processor is configured to execute one or more steps or functions according to program instructions stored on at least one carrier medium. In some embodiments, one or more electronic circuits are configured for performing selected steps or functions.

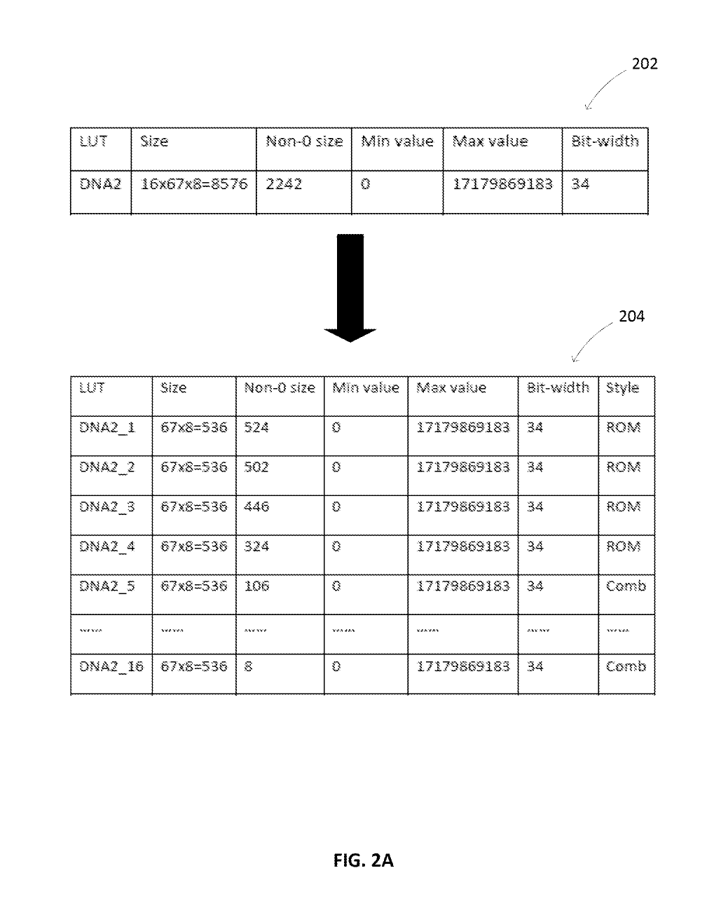

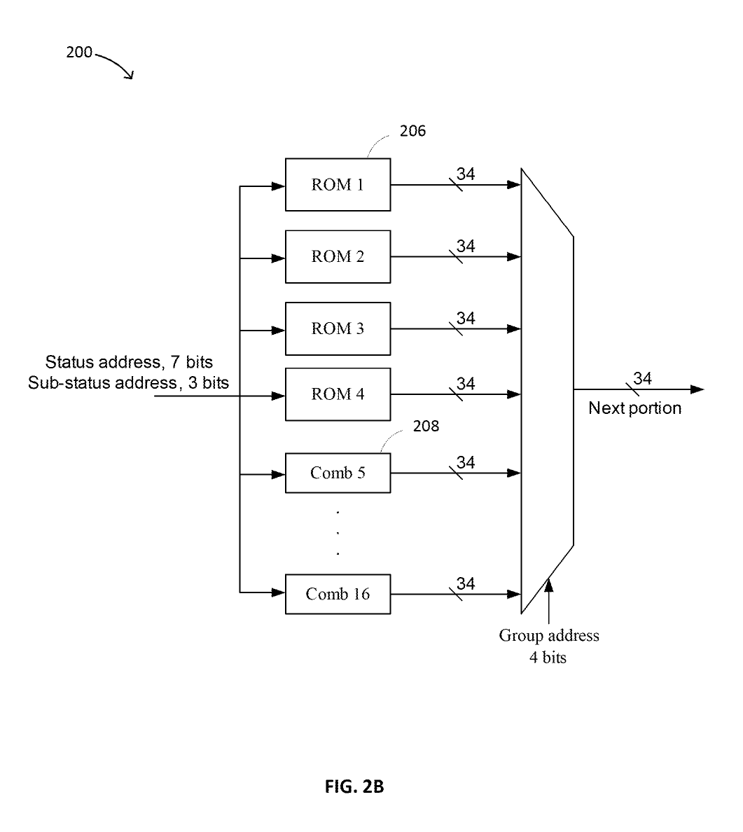

FIGS. 2A and 2B illustrate an embodiment of a system 200 including a mixture of ROM and combinational logic for accessing one or more values of a LUT. In some embodiments, the system 200 is configured for storing and accessing values of the DNA2 LUT referenced by table 202 in FIG. 2A, which is used to output a next portion value according to current state. In some embodiments, illustrated by table 202, the address (i.e. the current state) is composed of three variables: 16 possible groups, 67 possible statuses, and 8 possible sub-statuses. In some embodiments, the LUT includes many zero elements (e.g. 6334 of 8576), thus it is a relatively sparse matrix. ROM will assign same area to every element, no matter whether it is zero or not. However, combinational logic is more flexible, allowing merger of multiple addresses which have same element value. Accordingly, in the foregoing example, there are only 2242 valid address for combinational logic circuit storing the DNA2 LUT. However, compared with ROM implementation, combinational logic will consume more area for each individual element.

Table 204 illustrates the DNA2 LUT split into a selected number (e.g. 16) of sub-LUTs. In an embodiment, the system 200 includes one or more ROM devices 206 configured to store a first set of the sub-LUTs and one or more combinational logic circuits configured to store a second set of sub-LUTs. In some embodiments, the first set of sub-LUTs stored by the ROM 206 include a greater number of non-zero elements than the second set of sub-LUTs stored by the combinational logic 208. Accordingly, the LUT is broken down into a plurality of sub-LUTs stored by a mixture of cascaded ROM devices 206 and combinational logic circuits 208 to decrease hardware area of the LUT.

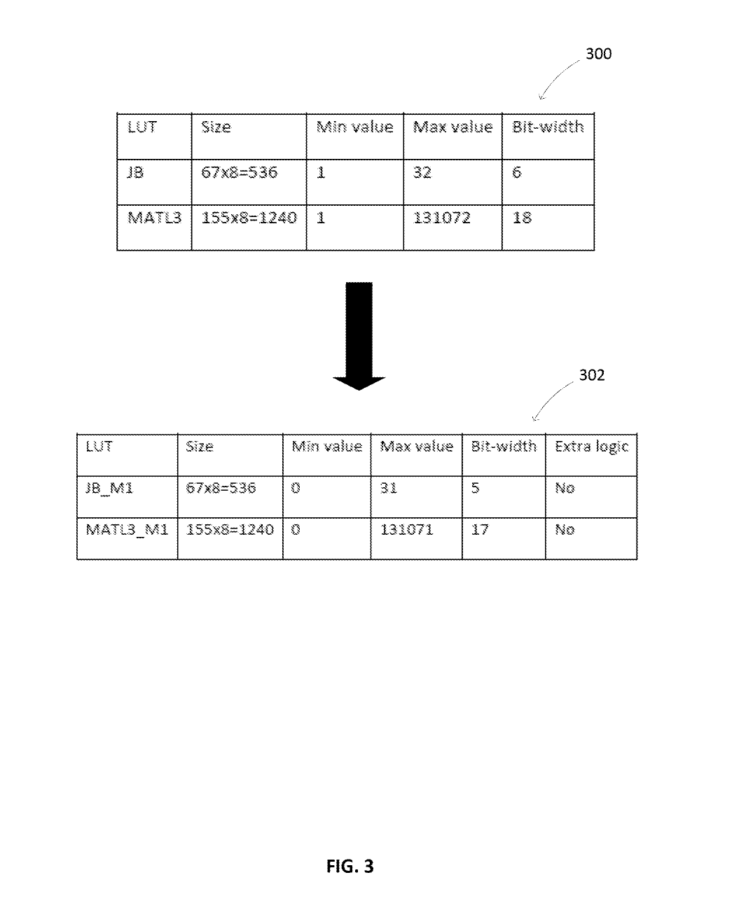

In some embodiments, illustrated by FIG. 3, a common value is subtracted from an LUT, such as the JB LUT or MATL3 LUT referenced in tables 300 and 302, to reduce bit width of LUT elements. As illustrated in table 300, the minimum value for some LUTs is 1, while maximum value is a power of 2 (e.g. 32=2̂5, 131072=2̂17). By subtracting 1 from the LUTs, as illustrated in table 302, the bit-width is reduced 1 bit. Doing so saves area and reduces timing delays. Since hardware design typically starts from 0, the subtracted value can be easily compensated by downstream logic.

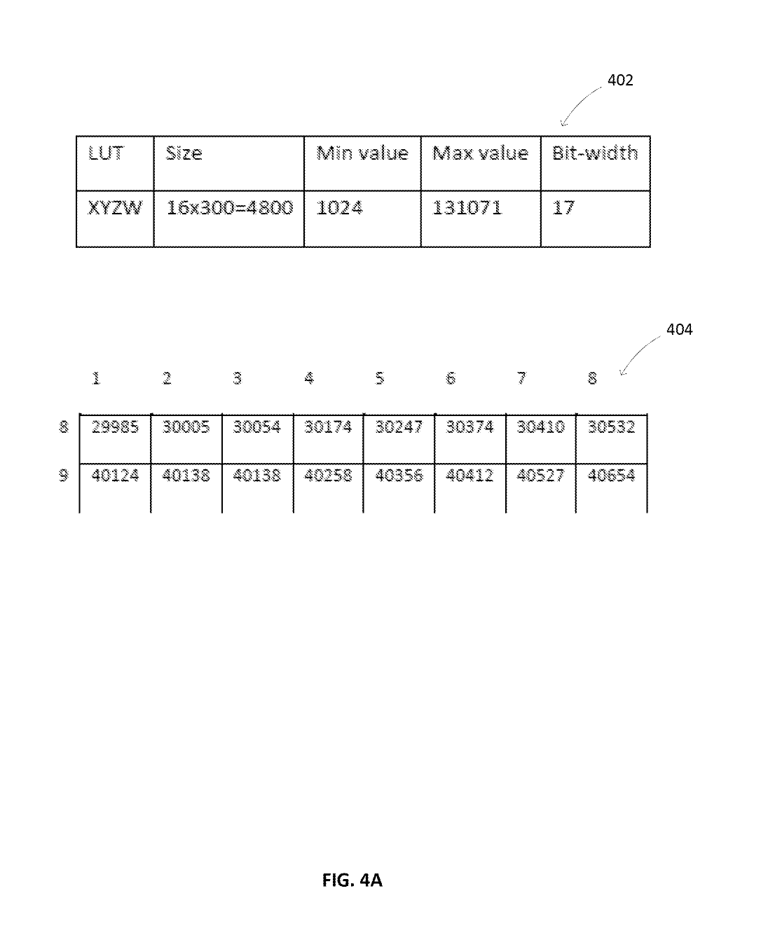

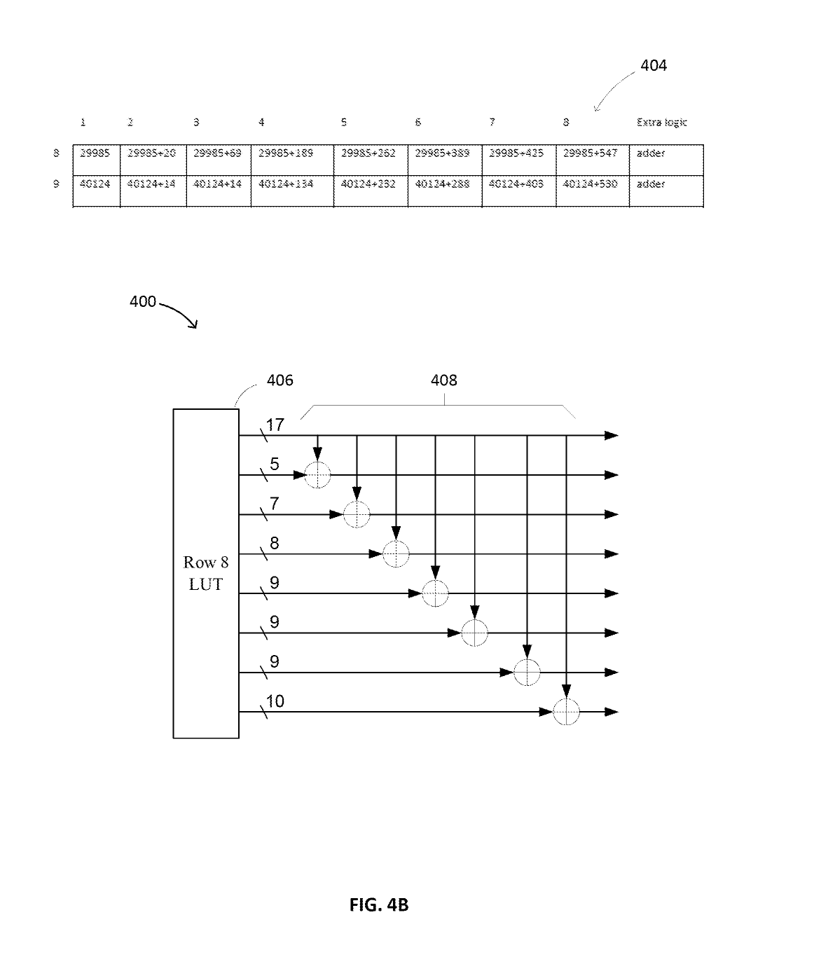

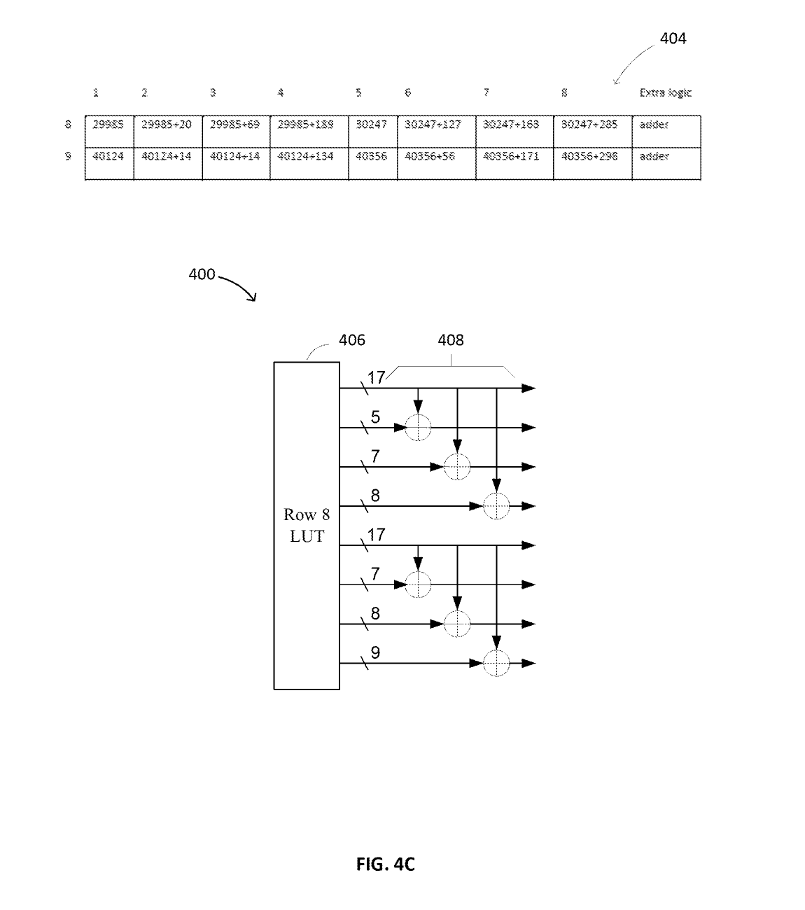

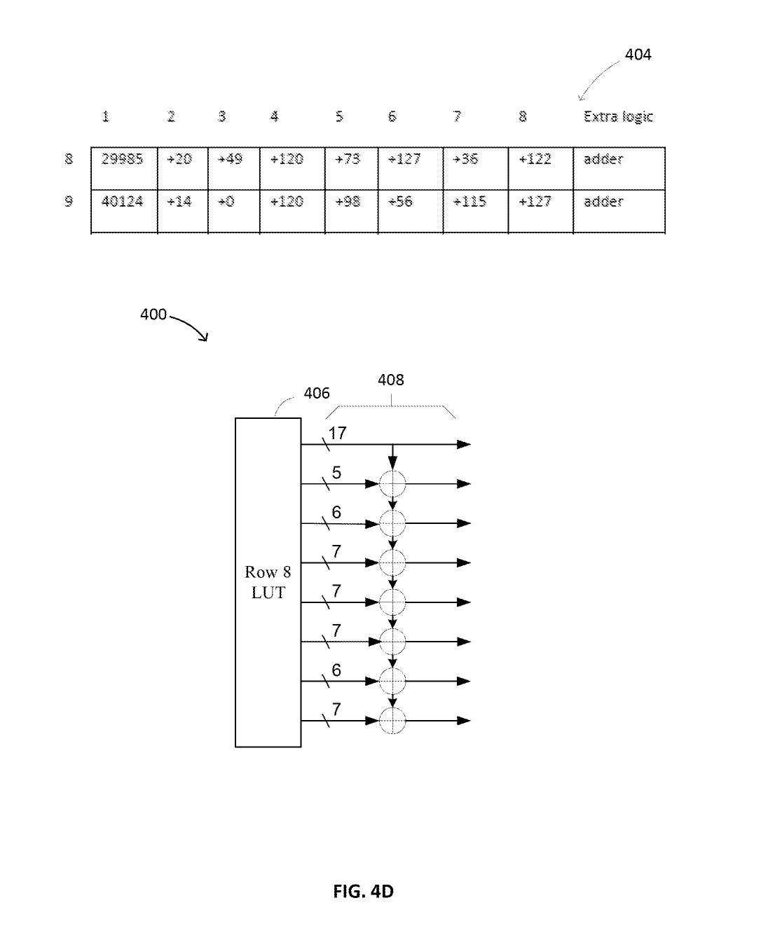

FIGS. 4A through 4D illustrate embodiments of a system 400 enabling a first plurality of “primary” values to be stored by ROM 406 while a second plurality of “secondary” values of a LUT are accessed (i.e. retrieved, determined, or calculated) by combinational logic 408 utilizing delta values. In some embodiments, an LUT, such as the XYZW LUT illustrated in table 402, illustrates an embodiment is a monotone non-decreasing LUT. An exemplary element of the LUT is illustrated by matrix 404.

In an embodiment, illustrated in FIG. 4B, a primary value of each row (e.g. 29985 for column 1 of row 8) is stored by ROM 406, while only delta values are stored for other columns, where the delta value is determined by a difference between a secondary value (of one of the other columns) and the primary value (of the primary column). By storing delta values instead of the secondary values in their entirety, bit width is significantly reduces. As illustrated in FIG. 4B, the system 400 includes ROM 406 configured to store the primary value of each row in addition to a plurality of delta values. The system 400 further includes one or more combinational logic circuits 408, such as one or more adders, configured to provide access to the secondary values of each row of the LUT by adding in the delta values. In some embodiments, the combinational logic 408 includes adders shared by all rows of the LUT.

In another embodiment, illustrated in FIG. 4C, two or more primary numbers are stored for each row (e.g. 29985 for column 1 and 30247 for column 5 of row 8). Delta values are stored for all other columns, where each delta value is determined according to a difference between a secondary value and the primary value from the nearest preceding column of the row. In another embodiment, illustrated in FIG. 4D, each delta value is determined according to a difference between a respective column and an immediately preceding column, thus allowing for significant reduction of storage area needed to store the primary value of each row and delta values associated with the secondary values.

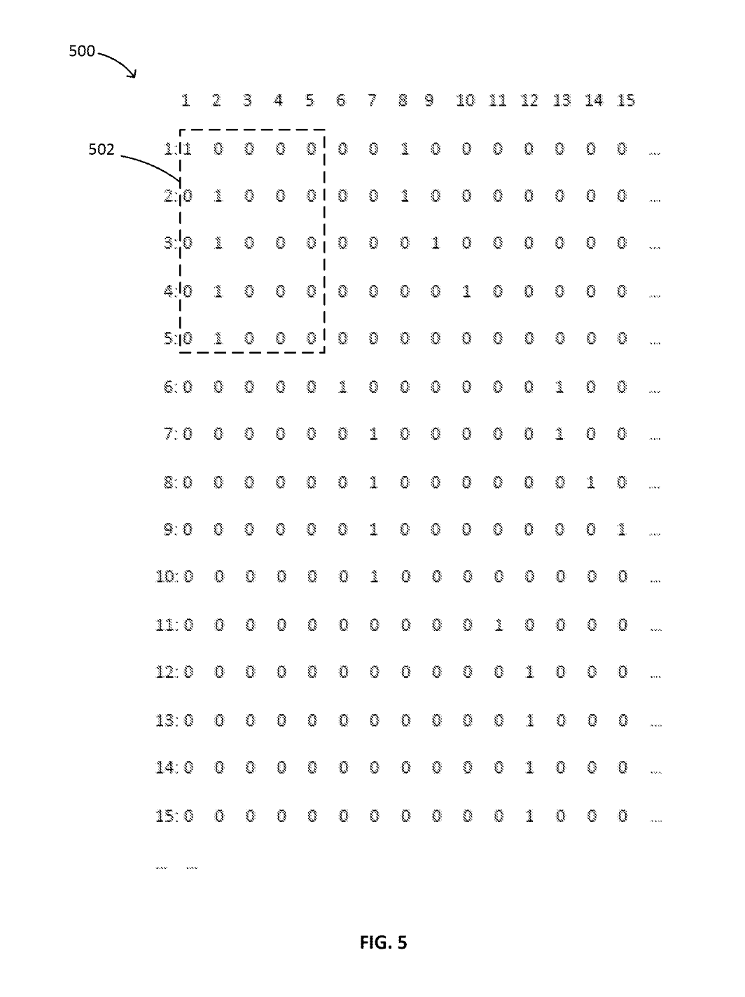

As previously discussed, conversion ROM to combinational logic advantageously balances area and timing for some LUTs, such as the LUT 500 illustrated in FIG. 5 (e.g. DM4 LUT—a basic transition matrix for MTR coding). In some embodiments, the LUT 500 is fully converted to combinational logic. In some embodiments, the LUT 500 is a sparse matrix (e.g. FIG. 5 depicts top left 15×15 of 300×300 DM4 LUT). In some embodiments, the LUT 500 is utilized to determine succeeding MTR states, indicated by 1 in the matrix, where the row index indicates a current state, and the column index indicates a next state. In some embodiments, each current state has one or two possible next states. In some embodiments, all indices for the non-zero elements are stored by ROM.

In some embodiments, simple combinational logic is configured to store the LUT 500. In some embodiments, the LUT 500 includes a larger matrix (e.g. 300×300 transition matrix) extended from a smaller matrix (e.g. basic 5×5 matrix). A level and offset is stored by the combinational logic to merge zero elements, such that 5 states constitute a level and the offset defines the order of a state in a level. Accordingly, all non-zero elements (i.e. states) are indicated by two variables: level (e.g. range from 1-60) and offset (e.g. range from 1-5). For example, state 6 is level 2 and offset 1, state 7 is level 2 and offset 2, state 12 is level 3 and offset 2, and so on. In some embodiments, the following combinational logic is used:

Second possible next state in DM4:
dm4_next2_lv = dm4_current_lv+1
dm4_next2_off = (dm4_current_off + ((dm4_current_off==1) ? 2 : 1)
First possible next state in DM4:
dm4_next1_lv = dm4_current_lv
dm4_next1_off = (dm4_current_off==1) ? 1 : 2

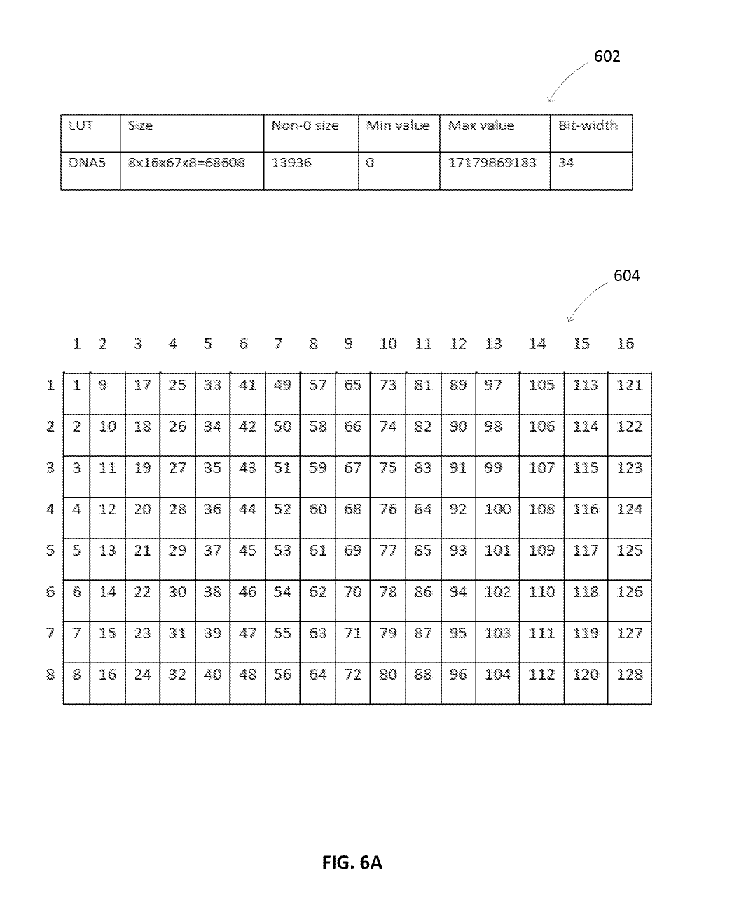

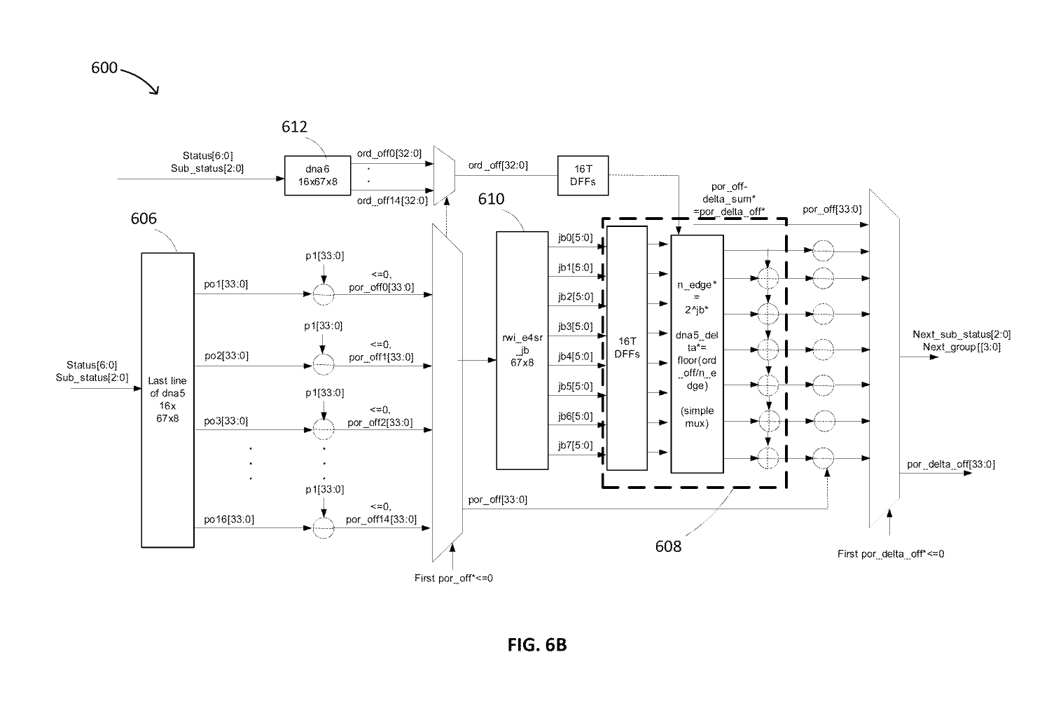

FIGS. 6A and 6B illustrate a system 600 where a first portion of an LUT is stored by ROM and a second portion of the LUT is accessed utilizing combinational logic. In some embodiments, the LUT is relatively large, such as the DNA5 LUT referenced in table 602 which is used in MTR coding to determine a state of a succeeding codeword. In some embodiments, the address (i.e. current state) is composed of two variables: 67 possible status, 8 possible sub-status, and the output is 8×16=128 possible monotone non-decreasing portions. In some embodiments, the output portions are compared with a predetermined portion to locate the next group and sub-status.

In some embodiments, the delta value between predetermined portion and target endpoint is required for subsequent operations. In some embodiments, the possible endpoint values are approximately in the range of 0 to 17179869183. In some embodiments the endpoint values are distributed to 16 possible groups, each group including 8 possible sub-statuses for a total of 128 possible endpoint values. The predetermined portion always falls into a zone of two monotone non-decreasing endpoint values. In some embodiments, during the MTR LUT generation algorithm, the target endpoint values in the 16 possible groups are calculated in advance and stored in the LUT for the real-time encoder/decoder. The target portion in the 8 possible sub-statuses of a group is determined utilizing approximate eigenvector values from an eigenvector matrix.

Table 604 illustrates 128 possible endpoint values for an individual address (one combined value of status and sub-status). In some embodiments, only a selected number of rows such as one primary row (e.g. last (8th) row) of the LUT element 604 is stored, and other (secondary) rows are calculated by combinational logic utilizing delta values (i.e. eigenvector values). For example, to determine value 37 of the LUT element 604, a stored value (e.g. 32) of the primary row is combined with delta values from the eigenvector matrix by combinational logic, as illustrated below:

Delta1=33−32; Delta2=34−33; Delta3=35−34; Delta4=36−35; Delta5=37−36; Value 37=value 32+delta1+delta2+delta3+delta4+delta5

In some embodiments, portion splitting logic is used to determine the delta values. In some embodiments, the 8 portion groups for sub-statuses of a determined end status are accessed through combinational logic utilizing delta values while the status rows (i.e. primary rows) are stored. In some embodiments, the portion splitting logic allows for significant reduction of LUT area (e.g. DNA5 LUT is area reduced up to ⅛ original size). In some embodiments, the logic is defined by the following MATLAB LUT generation code:

```
Block1:
dum0=gar_f(ij1); % 1 of 16 groups
dum1 = find(Jb( dum0, :)==1);  % get 8 sub-status in this group
for ij2=1:1:length×(dum1);  % get delta value
  n_edge=2\hat{ }(34 - 35 + dum1(ij2));
  DNA( 4+ij2, ij1, i, j)= floor((DNA4(j,dum0,i) - DNA3(j,dum0,i))/n_edge);
End
Block2:
d_PART=DNA(5:end,1:gar_l,i,j);
d_dum= % accumulate delta value to form monotone non-decreas-
ing 128 values
reshape(cumsum(reshape(d_PART,1,size(d_PART,1)*size(d_PART,2))),
  size(d_PART,1),size(d_PART,2));
DNA(5:end,1:gar_l,i,j) = d_dum;
```

As illustrated in FIG. 6B, the system 600 includes ROM 606 storing a selected primary row of each LUT element 604. A predetermined portion is compared with every eighth sub-status portion in 16 groups to locate the proper group to determine an end state. An approximate eigenvector matrix 610 (e.g. JB LUT) is searched utilizing the end state to determine an approximate eigenvector value for each sub-state. The portion number for every sub-state is calculated utilizing the approximate eigenvector value and path of number (i.e. order offset). Accumulation values of the portions are compared with the predetermined portion an additional time to locate the end sub-state. The system includes combinational logic 608 configured to receive the approximate eigenvector values from the eigenvector matrix 610. In some embodiments, the combinational logic replaces up to ⅞ of the LUT, add timing pressure but reducing area pressure.

In some embodiments, the path of a current end state address is defined by comparison between two LUTs (e.g. DNA4−DNA3). For timing consideration, the comparison values are directly stored as a new LUT 612 (e.g. DNA6=DNA4−DNA3). In some embodiments, the new LUT 612 replaces combinational logic (DNA4−DNA3) to relax timing pressure. In some embodiments, however, the new LUT 612 adds area pressure because DNA3 and DNA4 are required for other portions of the MTR coding algorithm.

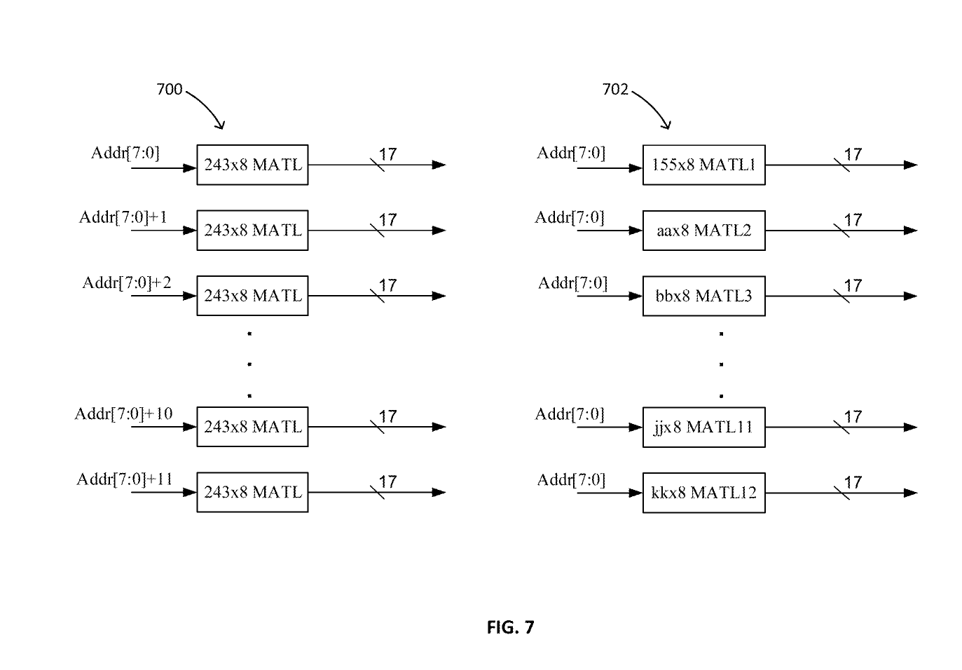

FIG. 7 illustrates an embodiment of a system 700 for accessing one or more values of an LUT having at least some invalid addresses, such as MATL LUT referenced in FIG. 7. In some embodiments, the size of the LUT is 243×8, but the possible number of address value is only 155, ranged from 1-243 (i.e. some values are invalid). In some embodiments, different address values require different numbers of elements in the LUT. In some embodiments, the maximum number of output elements for an individual address is 12, the minimum number of output elements for an individual address is 1, and every address has no overlapped element in LUT. In some embodiments, the system 700 includes 12 243×8 LUTs. In some embodiments, however, the system 700 has area=12×243×8 and critical timing path=mux 243×8 to 1.

According to the non-overlapped character, the same or functionally similar LUT is enabled by system 702. The LUT is split into 12 sub-LUTs, each having a single output associated with one of the 12 elements. Some LUT outputs are invalid for a specified address, resulting in an address range from 1 to 155. In some embodiments, the system 702 accordingly has area=243×8 and critical timing path=mux 155×8 to 1. The key aspect is that different addresses do not require the same element from the original LUT, so the multiple-output LUT is split into a plurality of single-output LUTs to reduce area.

HDDs with higher density are increasingly desired in the art. Accordingly, encoding methods, such as MTR coding, are sometimes used to achieve better SNR performance. Many LUTs are often required by modern encoding methods, and they are an obstacle for area and timing closure in hardware implementations. The foregoing systems and techniques are directed to reducing area and/or timing pressures for various encoding circuits and any other circuits relying on LUTs.

It should be recognized that in some embodiments the various functions or steps described throughout the present disclosure may be carried out by any combination of hardware, software, or firmware. In some embodiments, various steps or functions are carried out by one or more of the following: electronic circuits, logic gates, field programmable gate arrays, multiplexers, or computing systems. A computing system may include, but is not limited to, a personal computing system, mainframe computing system, workstation, image computer, parallel processor, or any other device known in the art. In general, the term “computing system” is broadly defined to encompass any device having one or more processors, which execute instructions from a memory medium.

Program instructions implementing methods, such as those manifested by embodiments described herein, may be transmitted over or stored on carrier medium. The carrier medium may be a transmission medium, such as, but not limited to, a wire, cable, or wireless transmission link. The carrier medium may also include a storage medium such as, but not limited to, a read-only memory, a random access memory, a magnetic or optical disk, or a magnetic tape.

It is further contemplated that any embodiment of the disclosure manifested above as a system or method may include at least a portion of any other embodiment described herein. Those having skill in the art will appreciate that there are various embodiments by which systems and methods described herein can be effected, and that the implementation will vary with the context in which an embodiment of the disclosure deployed.

Furthermore, it is to be understood that the invention is defined by the appended claims. Although embodiments of this invention have been illustrated, it is apparent that various modifications may be made by those skilled in the art without departing from the scope and spirit of the disclosure.

What is claimed is:

1. A system for accessing one or more values of a lookup table, comprising:
one or more read only memory devices configured to store a first plurality of values of the lookup table;
one or more combinational logic circuits configured to provide access to a second plurality of values of the lookup table; and
at least one processor in communication with the one or more read only memory devices and the one or more combinational logic circuits, the at least one processor configured to locate at least one value of the lookup table according to a selected address.

2. The system of claim 1, wherein the lookup table comprises a plurality of sub-lookup tables, each sub-lookup table stored by at least one of a read only memory device and a combinational logic circuit.

3. The system of claim 2, wherein the lookup table comprises a multiple-output lookup table, and each sub-lookup table comprises a single-output lookup table.

4. The system of claim 2, wherein the plurality of sub-lookup tables includes:
a first plurality of sub-lookup tables stored by the one or more read only memory devices; and
a second plurality of sub-lookup tables stored by the one or more combinational logic circuits.

5. The system of claim 1, wherein the first plurality of values stored by the one or more read only memory devices includes a greater number of non-zero elements than the second plurality of values stored by the one or more combinational logic circuits.

6. The system of claim 1, wherein the first plurality of values of the lookup table stored by the one or more read only memory devices includes a primary value of each row of a plurality of rows of the lookup table and a plurality of delta values for each row of the plurality of rows of the lookup table.

7. The system of claim 6, wherein a delta value is determined utilizing a difference between a secondary value of a row and the primary value of the row.

8. The system of claim 6, wherein a first delta value is determined utilizing a difference between a first secondary value of a row and a first primary value of the row, and a second delta value is determined utilizing a difference between a second secondary value of the row and a second primary value of the row.

9. The system of claim 6, wherein a first delta value is determined for a row utilizing a difference between a first secondary value of the row and the primary value of the row, and a second delta value is determined for the row utilizing a difference between a second secondary value of the row and the first secondary value of the row.

10. The system of claim 6, wherein the one or more combinational logic circuits are in communication with the one or more read only memory devices, wherein the second plurality of values accessible via the one or more combinational logic circuits includes a plurality of secondary values of each row determined utilizing the primary value of each row and the plurality of delta values for each row.

11. The system of claim 10, wherein the one or more combinational logic circuits include one or more adders.

12. The system of claim 1, wherein the first plurality of values of the lookup table stored by the one or more read only memory devices includes a primary row of the lookup table, wherein the second plurality of values accessible via the one or more combinational logic circuits includes a plurality of secondary rows of the lookup table, wherein each value of each row of the plurality of secondary rows is determined utilizing a primary value of the primary row and an eigenvector value.

13. A method of accessing one or more values of a lookup table, comprising:
storing a first plurality of values of the lookup table utilizing one or more read only memory devices;
providing access to a second plurality of values of the lookup table utilizing one or more combinational logic circuits; and
locating at least one value of the lookup table according to a selected address associated with the at least one value of the lookup table.

14. The method of claim 13, further comprising:
storing each one of a plurality of sub-lookup tables of the lookup table utilizing at least one of a read only memory device and a combinational logic circuit.

15. The system of claim 14, further comprising:
storing a first plurality of sub-lookup tables of the plurality of sub-lookup tables utilizing the one or more read only memory devices; and
storing a second plurality of sub-lookup tables of the plurality of sub-lookup tables utilizing the one or more combinational logic circuits, wherein the first plurality of values stored by the one or more read only memory devices includes a greater number of non-zero elements than the second plurality of values stored by the one or more combinational logic circuits.

16. The method of claim 13, further comprising:
storing a primary value of each row of a plurality of rows of the lookup table and a plurality delta values for each row of the plurality of rows of the lookup table utilizing the one or more read only memory devices includes, wherein a delta value is determined utilizing a difference between a secondary value of a row and the primary value of the row; and
accessing a plurality of secondary values of each row utilizing the one or more combinational logic circuits, wherein each one of the plurality of secondary values is determined utilizing the primary value of each row and at least one delta value of the plurality of delta values for each row.

17. The method of claim 13, further comprising:
storing a primary row of the lookup table utilizing the one or more read only memory devices; and
accessing a plurality of secondary rows of the lookup table utilizing the one or more combinational logic circuits, wherein each value of each row of the plurality of secondary rows is determined utilizing a primary value of the primary row and an eigenvector value.

18. A system for encoding data, comprising:
one or more read only memory devices configured to store a first plurality of values of the one or more lookup tables;
one or more combinational logic circuits configured to provide access to a second plurality of values of the one or more lookup tables; and
an encoder in communication with the one or more read only memory devices and the one or more combinational logic circuits, the encoder configured to encode data according to one or more values received from one or more lookup tables, wherein the one or more values are received by the encoder according to one or more addresses associated with operating states of the encoder.

19. The system of claim 18, wherein the encoder comprises a maximum transition run encoder.

20. The system of claim 19, further comprising:
a low-density parity-check encoder configured to receive the encoded data from the maximum transition run encoder, and further configured to process the data before the data is written to a storage medium.
